(19) United States
(12) Patent Application Publication
(10) Pub. No.: US 2015/0308618 A1
(43) Pub. Date: Oct. 29, 2015

(54) VEST-MOUNTED GIMBAL SUPPORT, AND A METHOD FOR ITS USE

(71) Applicant: Koncept Innovators, LLC., Myrtle Beach, SC (US)

(72) Inventor: Bertrand Valero, Myrtle Beach, SC (US)

(21) Appl. No.: 14/656,614

(22) Filed: Mar. 12, 2015

Related U.S. Application Data
(60) Provisional application No. 61/952,009, filed on Mar. 12, 2014.

(51) Int. Cl. F16M 13/04

(52) U.S. Cl. CPC F16M 13/04

(57) ABSTRACT

A vest-mounted gimbal support incorporates a vest, an arm supported on the vest, and a gimbal set including a first motor, a second motor mounted on the shaft of the first motor, and a camera support mounted on the shaft of the second motor, an inertial measurement unit, and a computer that receives input from the inertial measurement unit and activates the motors in response. The arm may have a shock absorber.

### RELATED APPLICATION DATA

This application claims priority to U.S. provisional application No. 61/952,009 filed on Mar. 12, 2014, the entirety of which is incorporated herein by reference.

### TECHNICAL FIELD

Embodiments disclosed herein relate generally to camera support systems, and in particular to the use of computer-assisted gimbals.

### BACKGROUND ART

The use of counterweight-based gimbal systems to produce steady handheld camera shots has enabled professionals to produce work of exceptional quality, but there remains room for improvement. Counterweight gimbals assemblies are challenging to balance, and owing to the counterweights must necessarily be heavy. Even an expertly balanced system can require a great deal of practice to master, and necessarily requires a tradeoff, sacrificing the ability to change the angle of the camera at will for the steadiness that comes with countering involuntary movement. The use of motorized gimbals with motion sensors can help solve those problems, but still does not account for the translational motions that an operator can encounter while moving rapidly with the camera assembly

Therefore, there remains a need for an effective handheld attitude control system.

### SUMMARY OF THE EMBODIMENTS

A device is disclosed for a vest-mounted gimbal support device. The device includes a support vest, worn on the person of an operator, and a support arm, mounted on the support vest. The device further includes a gimbal set, mounted on the support arm, the gimbal set including at least one first electric motor having a shaft, at least one second electric motor attached to the shaft of the first motor, the second motor having a shaft, and a camera bearing member attached to the shaft of the second electric motor. The device includes an inertial measurement unit detecting and transmitting a rotational motion. The device also includes a computing device configured to receive input from the inertial measurement unit, to determine a kinetic response based upon that input, and to activate the first electric motor and second electric motor based upon the kinetic response.

In a related embodiment of the device the vest also includes a rigid frame to which the arm attaches. In another embodiment, the arm further includes at least one shock absorber. The at least one shock absorber is a spring, in another embodiment. In an additional embodiment, the arm also includes at least one joint. In another embodiment, the at least one joint includes at least one horizontally articulating joint. In another embodiment, the at least one joint includes at least one vertically articulating joint. In an additional related embodiment, the at least one shock absorber includes at least one shock absorbing assembly having a first joint plate, a second joint plate, a first bar having a proximal end rotably joined to the first joint plate and a distal end rotably joined to the second joint plate, a second bar having a proximal end rotably joined to the first joint plate and a distal end rotably joined to the second joint plate, the second bar parallel to the first bar, and a biasing means having a bias that resists changes in distance between the first joint plate and the second joint plate. In still another embodiment, the biasing means has a proximal end connected to the first joint plate near the proximal end of the first bar, and a distal end connected to the second joint plate near the distal end of the second bar. The biasing means includes a spring in a related embodiment. In an additional embodiment, the at least one shock absorbing assembly is isometrically adjustable. In another embodiment, the gimbal set has at least one handle having a lower end and a hollow portion open at the lower end of the handle, and the gimbal set is attached to the arm by lowering the hollow portion of the handle over a pin set on the end of the arm. In another embodiment still, the pin and the hollow portion are formed so that the pin fits snugly within the hollow portion.

In another embodiment, the shaft of the first motor has a first axis of rotation, and the shaft of the second motor has a second axis of rotation that is not parallel to the first axis of rotation. In yet another embodiment, the gimbal further includes a third motor having a shaft, wherein the first motor is fixed to the shaft of the first motor, and the computing device is further configured to activate the third motor based upon the kinetic response. In another embodiment still, the shaft of the first motor has a first axis of rotation, and the shaft of the second motor has a second axis of rotation that is not parallel to the first axis of rotation, and the shaft of the third motor has a third axis of rotation, and the third axis of rotation is not parallel either to the first or second axis of rotation.

A method is also disclosed for automated camera attitude control. The method includes receiving, by a computing device incorporated in a vest-mounted gimbal device as provided in above, from the inertial measurement unit, a signal describing a rotational motion, determining, by the computing device, a kinetic response based upon that input, and activating the first electric motor and second electric motor based upon the kinetic response.

In a related embodiment of the method, determining the kinetic response further involves determining an equal and opposite response to cancel out the rotational motion. In an additional embodiment, determining the kinetic response also involves determining an overall change of orientation. Still another embodiment involves receiving, by the computing device, from a manual data entry device, a command specifying a change in orientation, and activating, by the computing device, the first electric motor and second electric motor according to the change in orientation.

Other aspects, embodiments and features of the device will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the device.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1 is a schematic diagram depicting a computing device;

FIG. 2A is a schematic diagram depicting an embodiment of the disclosed device;

FIG. 2B is a schematic diagram depicting an embodiment of a support arm, as described herein;

FIG. 2C is a schematic diagram depicting an embodiment of a gimbal set as described herein;

FIG. 2D is a cutaway illustration of an embodiment of a gimbal set showing a handle with a hollow portion;

FIG. 2E is a cutaway illustration of an embodiment of a gimbal set having a handle with a hollow portion, attached to the end of an embodiment of a support arm; and

FIG. 3 is a flow chart illustrating one embodiment of the disclosed method.

### DETAILED DESCRIPTION OF SPECIFIC EMBODIMENTS

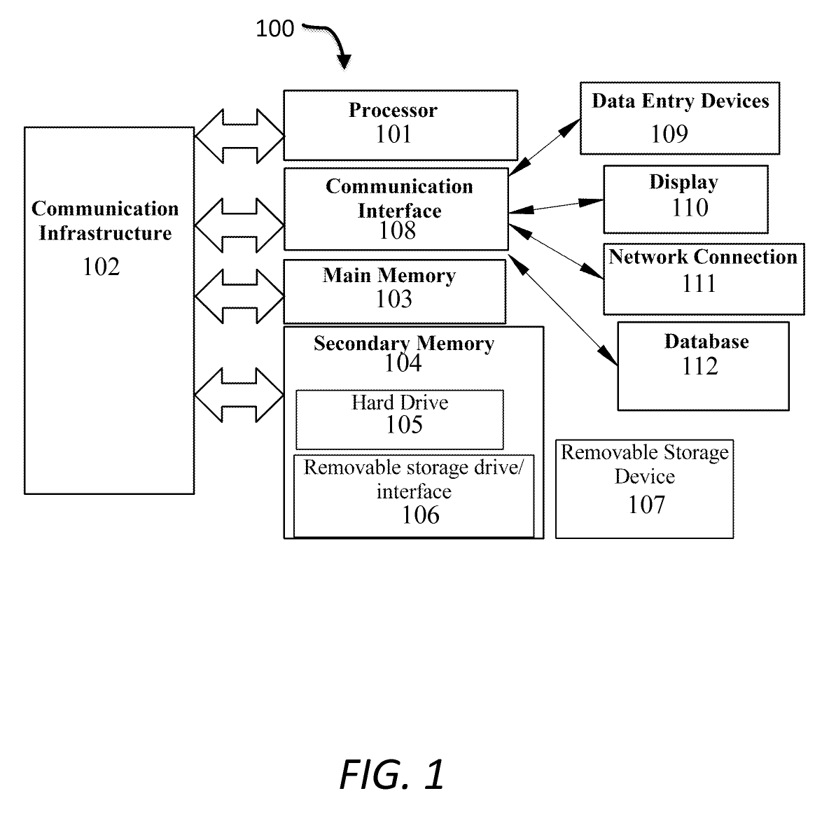

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

Embodiments of the disclosed device permit an operator to obtain superior, steady camera shots. The brushless gimbal assembly in some embodiments is lightweight and provides superior quality over the older counterweight gimbal systems. The arm and vest assembly help support the weight of the camera and gimbal system, in some embodiments, while the shock absorbers included in other embodiments help to limit the impact of shocks and translational movements, achieving smoother shot quality than gimbals alone.

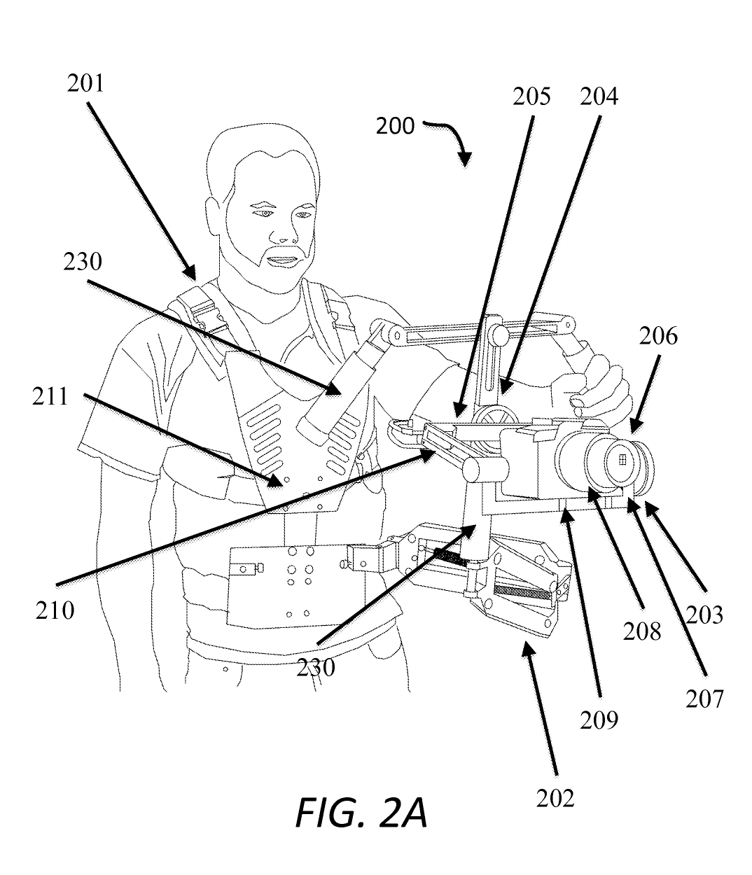

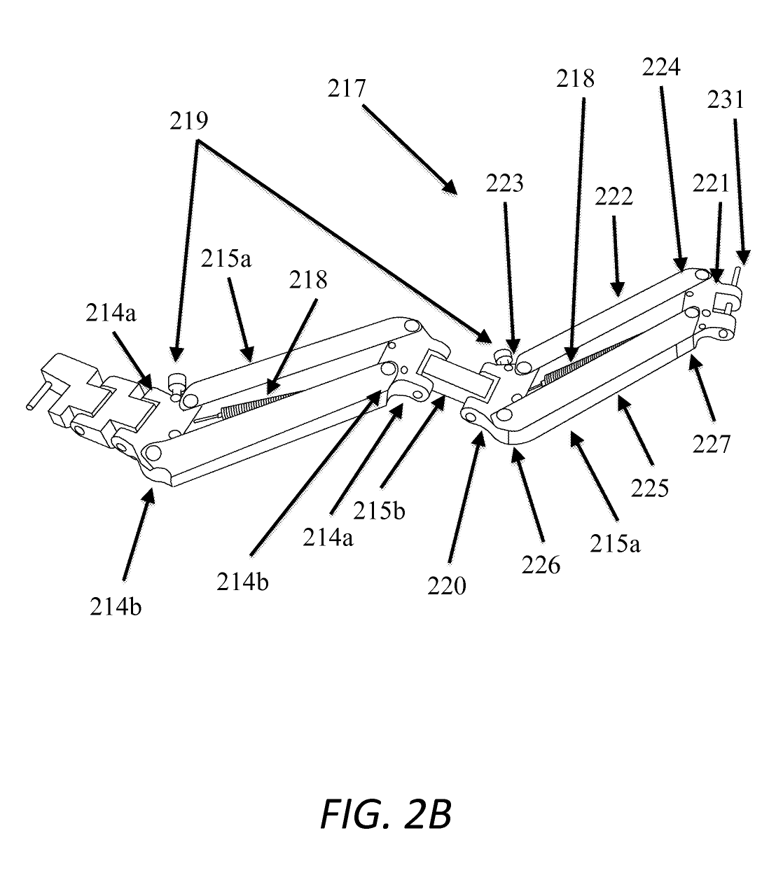

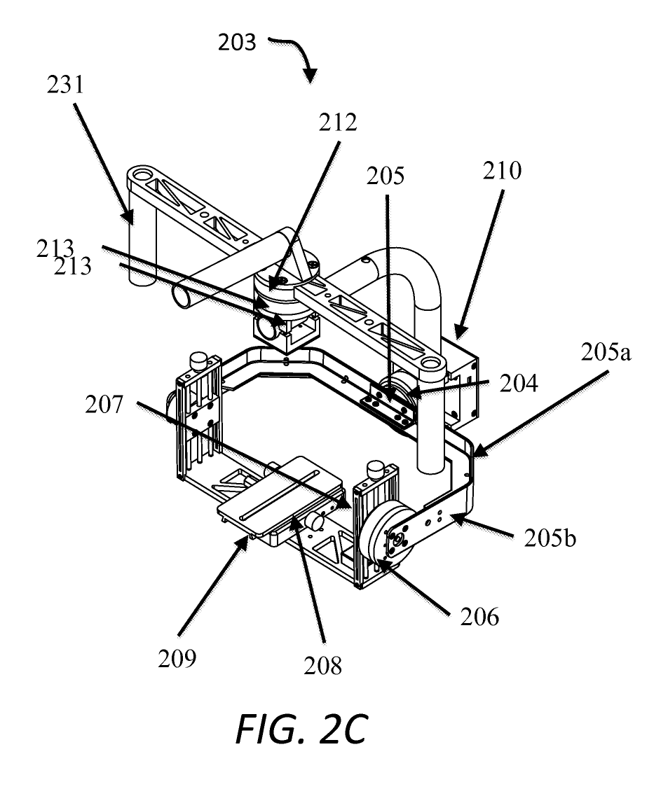

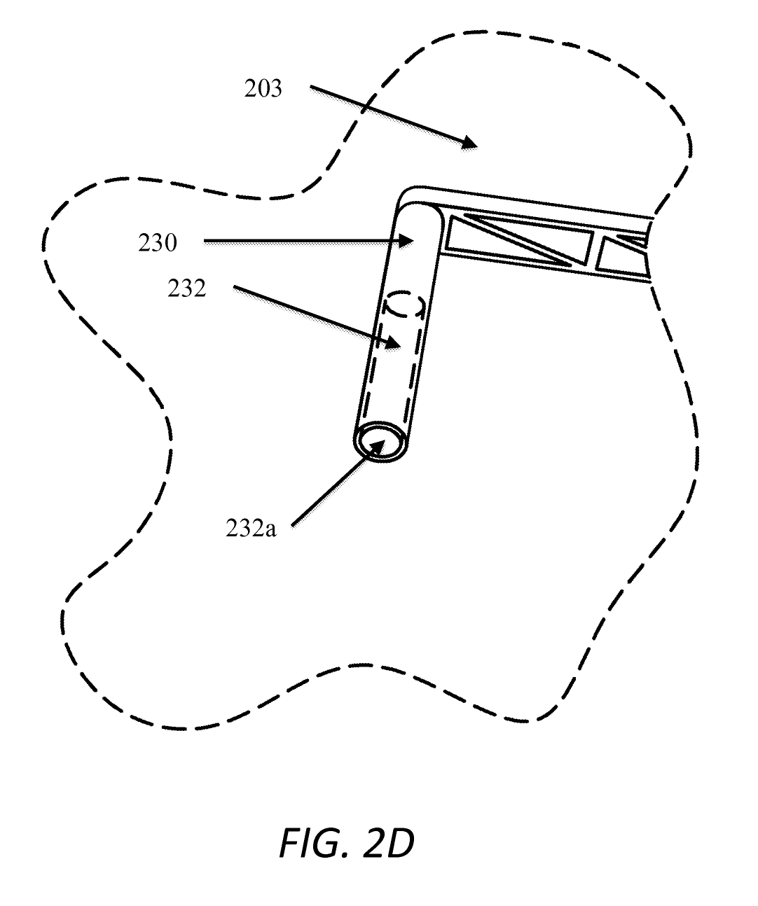

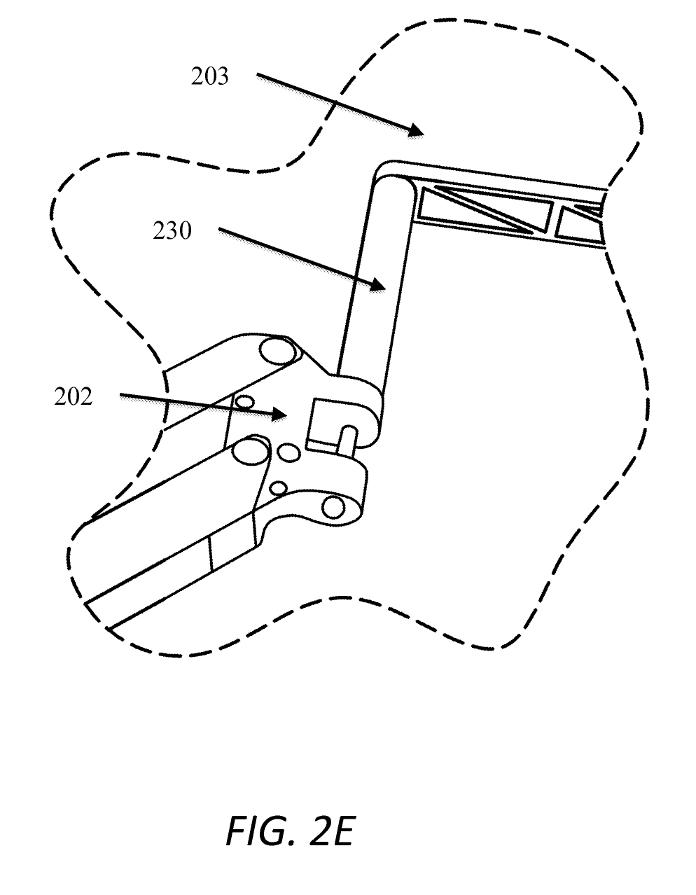

FIG. 2A depicts a vest-mounted, gimbal support device 200. As an overview, the device 200 includes a support vest 201, worn on the person of an operator. The device 200 includes a support arm 202, mounted on the support vest 201. The device includes a gimbal set 203, mounted on the support arm 202. The gimbal set 203 includes at least a first electric motor 204, having a shaft 205. The gimbal set 203 includes at least one second electric motor 206 attached to the shaft 205 of the first electric motor 204; the second electric motor 206 also has a shaft 207. The gimbal set 203 includes a camera support member 208 attached to the shaft of the second electric motor 206. The device 200 also includes an inertial measurement unit 209, adapted to detect a rotational motion and transmit data responsive to that detection. The device 200 additionally includes a computing device 210 configured to receive the data from the inertial measurement unit 209, to determine a kinetic response based upon that data, and to activate the first electric motor 204 and second electric motor 206 based upon the kinetic response.

Still viewing FIG. 2A in greater detail, the device 200 includes a support vest 201, worn on the person of an operator. The vest 201 may be made of any suitable material. Materials composing the vest 201 may include leather. Materials composing the vest 201 may include a natural polymer. Materials composing the vest 201 may include rubber. Materials composing the vest 201 may an artificial polymer, such as plastic. Materials composing the vest 201 may include a natural textile. Materials composing the vest 201 may include cotton; for instance, the vest 201 may be composed at least in part of canvas. The vest 201 may be composed at least in part of flax. The vest 201 may be composed at least in part of hemp. The vest 201 may be composed at least in part of hemp. The vest 201 may be composed at least in part of silk. The vest 201 may be composed at least in part of animal hair, such as wool. Materials composing the vest 201 may include a synthetic textile. Materials composing the vest 201 may include nylon. Materials composing the vest 201 may include polypropylene. Materials composing the vest 201 may include polyester.

In some embodiments, the vest 201 has padding. The padding may be natural fibrous material. The padding may be animal hair. The padding may be wool. The padding may be feathers. The padding may be a vegetable fiber, such as cotton wool. The padding may be an artificial fibrous material. The padding may be a fibrous polymer material, such as polyester wool. The padding may be a natural foam material. The padding may be sponge. The padding may be latex foam. The padding may be a synthetic foam material. The padding may be a polymer foam, such as polyurethane foam. The padding may be synthetic latex foam. The foam may be open-cell foam. The foam may be closed-cell foam. The foam may be dual-density foam. The foam may have multiple densities. The foam may be compression-molded. A part of the vest 201 may be rigid. The rigid portion of the vest may be metal. The rigid portion of the vest 201 may be a hard polymer such as plastic. In some embodiments, the vest includes a rigid frame 211 to which the arm attaches. The frame 211 may include bars. The frame 211 may include panels. In some embodiments, the frame 211 is a plate substantially covering the chest and abdomen of the operator. The plate may have openings for ventilation.

Some embodiments of the vest 201 include at least one strap. The strap may be composed of any material or combination of materials suitable for the composition of the vest 201. In some embodiments, the at least one strap is composed of flat webbing. In other embodiments, the at least one strap is composed of tubular webbing. Some embodiments of the vest 201 include at least one fastener. In some embodiments, the at least one fastener is a snap. In some embodiments, the at least one fastener is a hook and loop fastener. In some embodiments, the at least one fastener is a button. In some embodiments, the at least one fastener is a buckle. The fastener is a hook-and-eye fastener in some embodiments. The fastener may be a cam buckle. The fastener may be a spring buckle. The fastener may be a slide release buckle. The fastener may be a double-loop frame style buckle. The fastener may be a single-loop frame style buckle. The fastener may be a prong frame-style buckle. The fastener may be a plate buckle. The fastener may be a box-out buckle. The fastener may be a clip buckle. The fastener may be a snap buckle. The fastener may be a clasp. The fastener may be a tension lock. The fastener may be a ladder lock. The fastener may be a tri glide.

The fastener may be adjustable. Some fasteners, such as the double loop buckle or ladder lock, are inherently adjustable. A fastener that is not adjustable inherently may be made adjustable by including an adjustable form in its design. For example, either the male or female half of a slide-release buckle may be fused to a tension lock through which the strap is threaded, making the slide-release buckle adjustable. The fastener may be composed of any material of sufficient durability, hardness, and elasticity to perform the structural requirements of that type of fastener. The fastener may be metal. The fastener may be a hard polymer such as plastic. Where the fastener is a button, the fastener may be virtually any material sufficiently rigid to catch the buttonhole.

The device 200 includes a support arm 202, mounted on the support vest 201. The arm 202 may be permanently attached to the vest. The arm 202 may be welded to the vest 201. The arm 202 may be riveted to the vest 201. In other embodiments, the arm 202 is detachably attached to the vest 201. In an embodiment, the arm 202 is detachably attached to the vest 201 if the arm 202 may be repeatedly detached from and reattached to the vest 201 an indefinite number of times while suffering essentially no damage. The attachment may be accomplished using any fastener as described above in reference to FIG. 2A. The attachment may be accomplished using a screw. The attachment may be accomplished using a bolt. The attachment of the arm 202 to the vest 201 may be accomplished by inserting a pin on the end of the arm into a receiving hole on the vest; the attachment may further be accomplished by tightening a screw to fix the pin in the hole. The manner of the attachment of the arm 202 to the vest 201 may allow the arm 202 to be movable with respect to the vest 201; for example, the end of the arm 202 that attaches to the vest 201 may incorporate a joint, as set forth in more detail below.

The arm 202 may be constructed of any material suitable for the construction of the rigid frame 211, as described above in reference to FIG. 2A. As shown in FIG. 2B, in some embodiments the arm 202 includes at least one joint 214. In some embodiments, the at least one joint 214 includes at least one horizontally articulating joint 214a. In other embodiments, the at least one joint 214 includes at least one vertically articulating joint 214b. Some embodiments of the arm 202 contain both at least one vertically articulating joint 214b and one horizontally articulating joint 214a. For instance, the arm 202 may have a plurality of sections 215 connected by joints 214, and the joints may alternate between vertical 214b and horizontal 214a joints; as an example, there may be a horizontal joint 214a close to the connection of the arm 202 to the vest 201, followed by a vertical joint 214b connecting to a section 215a intended to move through a changing vertical angle when the vertical joint 214b articulates. Continuing the example, that section 215a, in turn, may connect via a vertical joint 214b to a subsequent section, which may connect via a horizontal joint 214a to an additional section 215b intended to move through a varying angle in the horizontal plane when the horizontal joint 214a articulates. Some sections 215 may be longer than other sections. For example, the horizontally movable sections 215b may be relatively long, and the vertically movable sections 215a may be relatively short. In other embodiments, the vertically movable sections 215a are relatively long and the horizontally movable sections 215b are relatively short. In some embodiments, a set of three consecutive sections 215 is connected in a way that allows the middle section to change its angle while the two end sections remain substantially parallel; as an example, the middle section may connect to each end section via a vertical joint, whereby the middle section can adjust its vertical angle while both end sections remain horizontal through the entire range of motion. In one embodiment, this occurs because the middle section is made up of two parallel bars, each bar rotably connected to each end section, as set forth in more detail below.

In some embodiments, the arm includes at least one shock absorber 217. The shock absorber 217 may include a biasing means 218 disposed such that its bias resists articulation of the joint in either direction from a neutral position. The biasing means 218 may be a spring. The biasing means 218 may be a gas piston. The biasing means 218 may be an elastic member such as a rubber band. The biasing means 218 may be a weight. The neutral position may be chosen by adjusting the bias in the biasing means 218; for instance, where the biasing means 218 is a spring, the length of the biasing means may be changed, to alter the equilibrium point of the spring. The shock absorber 217 may include an adjustor 219 for changing the bias of the biasing means. The adjustor 219 may change the length of the biasing means. The adjustor 219 may change the angle of the biasing means. The adjuster 219 may alter the location of an endpoint of the biasing means. In one embodiment, the adjustor 219 is a screw. The screw may be connected to a handle to permit manual adjustment. The screw may be connected to a motor that turns the screw to adjust the biasing means; the motor may be controlled by a switch. The motor may be controlled by the computing device 210. The shock absorber 217 may include a damper. In one embodiment, a damper is a component that resists or reduces oscillatory motion induced by the biasing means. The damper may introduce friction; for instance, the damper may involve a friction-introducing pad in one or more joints. The damper may involve resistance to pressure changes; for instance, the damper may include a gas piston that allows gradual pressure changes within the piston in response to movement of the shaft of the piston. The damper may involve resistance to fluid motion; for instance, the damper may involve a fluid-filled piston in which the movement of the shaft requires displacement of fluid. In some embodiments, the shock absorber 217 acts to smooth out sudden translational movements, as a complement to the gimbal set 203, and also helps to support the weight of the gimbal set 203 and camera.

In some embodiments, as shown in, the shock absorber 217 includes at least one shock absorbing assembly that contains a first joint plate 220, a second joint plate 221, a first bar 222 having a proximal end 223 rotably joined to the first joint plate 220 and a distal end 224 rotably joined to the second joint plate 221, a second bar 225 having a proximal end 226 rotably joined to the first joint plate 220 and a distal end 227 rotably joined to the second joint plate 221, the second bar 225 parallel to the first bar 222, and a biasing means 218 having a bias that resists changes in distance between the first joint plate 220 and the second joint plate 221. The biasing means may be any biasing means as disclosed above in reference to FIG. 2B. The bias may resist increases in the distance between the first joint plate 220 and the second joint plate 221. The bias may resist decreases in the distance between the first joint plate 220 and the second joint plate 221. The bias may resist both increases and decreases in the distance between the first joint plate 220 and the second joint plate 221; the bias may act to hold the assembly in a particular situation where any torque on the joints attendant to gravity combines with the bias to cancel out all forces that could induce motion in the shock absorbing assembly. In some embodiments, the parallel arrangement of the first bar 222 and second bar 225 has the result that any rotation of the bars through their rotable connections to the joint plates necessarily changes the distance between the first joint plate 220 and the second joint plate 221. The shock absorbing assembly may include a damper as described above in connection to FIG. 2A. In some embodiments, the biasing means has a proximal end connected to the first joint plate near the proximal end of the first bar, and a distal end connected to the second joint plate near the distal end of the second bar. In some embodiments, the biasing means includes an adjuster as disclosed above in reference to FIG. 2A.

In one embodiment, the at least one shock absorbing assembly is isometrically adjustable. In one embodiment, the shock absorbing assembly is isometrically adjustable if the force exerted on the two joint plates 220-221 acts to hold the shock absorbing assembly substantially in equilibrium at any angle to which the operator rotates the shock absorbing assembly. The isometrically adjustability may be effected by a motor that adjusts the equilibrium point of the system by adjusting the bias of the biasing means, as disclosed above in reference to FIG. 2A. In another embodiment, the biasing means acts on a drum located near the distal end 227 of the second bar 225, the drum having wound on it a cable that attaches near the proximal end 223 of the first bar 222, such that a change by the operator in the relative positions of the joint plates 220-221 causes the drum to rotate, either winding or unwinding the cable, and thus adjusting the equilibrium point of the shock-absorbing assembly; the assembly may also include an adjuster, as set forth above in reference to FIG. 2A, that enables the operator to adjust the precise location of the endpoint of the cable, to adjust the system to an appropriate equilibrium point given the variable weight of the camera.

The device includes a gimbal set 203, mounted on the support arm 202. The gimbal set 203 may be detachably attached to the end of the arm 202 according to any means of attachment as described above in reference to FIG. 2A. In some embodiments, the device 200 includes at least one handle 230 for the operator to hold the gimbal set 203 where it joins the arm 202; the handle 230 may be rigidly attached to the portion of the gimbal set 203 that is attached to the end of the arm 202. As shown in FIG. 2A, the gimbal set 203 may be attached to the end of the arm via the handle 230; for instance, the handle may contain a hollow portion with an opening at the lower end of the handle 230, and the gimbal set 203 may be attached to the end of the arm by lowering the hollow portion of the handle over a pin on the end of the arm. FIG. 2B shows a pin 231 on the end of the arm 202, which may be inserted into the handle 230. FIG. 2D shows an exemplary illustration of a portion of a gimbal 203 with handle 231 having a hollow portion 232, the hollow portion 232 having an opening 232a at the bottom end of the handle 231. FIG. 2E shows an exemplary illustration of a portion of a gimbal 203 with its handle 230 inserted over a pin (not shown) on the end of an arm 202. In some embodiments, the hollow portion of the handle fits snugly over the pin; as an example, where the pin is cylindrical with a first radius, the hollow portion of the handle may be cylindrical with a second radius substantially equal to or very slightly larger than the first radius.

FIG. 2C illustrates one embodiment of the gimbal set. The gimbal set 203 includes at least a one first electric motor 204, having a shaft 205. The first electric motor 204 may be any device that converts electrical energy into rotational kinetic energy. The first electric motor 204 may be a brushless motor. The first electric motor 204 may be a permanent-magnet synchronous motor. The first electric motor 204 may be a permanent magnet motor. The first electric motor 204 may be a reluctance-based motor, such as a switched reluctance motor, an induction motor, or an asynchronous induction motor. In some embodiments, the first electric motor 204 includes one or more elements to convert direct current to alternating current. The elements may include an inverter. The elements may include a switching power supply. In one embodiment, the shaft 205 is the element of the first electric motor 204 that the first electric motor 204 causes to rotate relative to the end of the arm 202 on which the gimbal set 203 is mounted. The shaft 205 may have any shape required for the intended purpose of the first electric motor 204. The shaft 205 may be formed into a bracket to hold the remainder of the gimbal and the camera, as set forth in more detail below.

The gimbal set 203 includes at least one second electric motor 206 attached to the shaft 205 of the first electric motor 204; the second electric motor 206 also has a shaft 207. The shaft 207 of the second motor 206 is the element of the second electric motor 206 that the second electric motor 206 causes to rotate relative to the second electric motor 204. In some embodiments, the shaft 205 of the first motor 204 has a first axis of rotation, and the shaft 207 of the second motor 206 has a second axis of rotation that is not parallel to the first axis of rotation. The second axis of rotation may be orthogonal to the first axis of rotation. Where the shaft 205 of the first motor forms a bracket, the bracket may have a first member 205a that runs orthogonally to the first axis of rotation. The first member 205a may be substantially bisected by the first axis of rotation. The bracket may include a second member 205b. The second member 205b may be substantially orthogonal to the first member. The second electric motor 206 may be mounted on the second member 205b. In some embodiments, the bracket includes a third member 205c. The third member 205c may be located on the end of the first member 205a opposite the end on which the second member 205b is located. The third member 205c may be parallel to the second member 205b. In some embodiments, the third member 205c has a bearing facing the second electric motor 206. The shaft 207 of the second electric motor 206 may be journaled on the bearing. One motor of the at least one second motor 204 may be located in place of the bearing. In additional embodiments, the gimbal further includes a third motor 212 having a shaft 213, and wherein the first motor is fixed to the shaft 213 of the third motor 212. In one embodiment, the shaft 205 of the first motor 204 has a first axis of rotation, and the shaft 207 of the second motor 206 has a second axis of rotation that is not parallel to the first axis of rotation, and the shaft 213 of the third motor 212 has a third axis of rotation, and wherein the third axis of rotation is not parallel either to the first or second axis of rotation.

In some embodiments, the camera bearing member 208 is attached to the shaft 207 of the second electric motor 206. The camera bearing member 208 may have a camera attachment component. The camera attachment component may include at least one screw. The screw may be adapted to attach to a threaded portion of a camera; for instance, the screw may be adapted for insertion in a threaded hole in the camera for attachment of the camera to a tripod. The camera attachment component may include a clamp adapted to hold the camera by clamping the body of the camera. The camera bearing member 208 may include a balancing adjustment device. The balancing adjustment device may permit the attachment component to be moved to balance the camera on the camera bearing member 208. In some embodiments, the balancing adjustment device can move the attachment component along a single axis. In other embodiments, the balancing adjustment device can move the attachment component along two axes; the two axes may be orthogonal. In some embodiments, the balancing adjustment device moves the attachment component along at least one axis using at least one screw.

The device 200 also includes an inertial measurement unit 209, adapted to detect a rotational motion and transmit data responsive to that detection. In one embodiment, an inertial measurement unit 209 detects its attitude, direction of movement, and acceleration, and transmits data describing the detected attitude, direction of movement, and acceleration to the computing device 210. The inertial measurement unit 209 may include at least one accelerometer; the at least one accelerometer detects inertial acceleration of the inertial measurement unit 209. In some embodiments, the inertial measurement unit 209 has three accelerometers whose axes of measurement span three dimensions; the outputs of the three accelerometers combine to describe the direction of acceleration in three dimensions of the inertial measurement unit. The axes of measurement of the three accelerometers may be orthogonal to each other. In some embodiments, the inertial measurement unit 209 includes at least one gyroscope; the at least one gyroscope detects the rotational position of the inertial measurement unit with respect to a chosen coordinate system. In some embodiments, the inertial measurement unit 209 includes three gyroscopes having axes that span three dimensions; the three axes may be mutually orthogonal. The inertial measurement unit 209 may include at least one magnetometer.

The device 200 additionally includes a computing device 210 configured to receive the data from the inertial measurement unit 209, to determine a kinetic response based upon that data, and to activate the first electric motor 204 and second electric motor 206 based upon the kinetic response. The computing device 210 may be a computing device 100 as described above in reference to FIG. 1. The computing device 210 may be a microprocessor. The computing device 210 may be a solid-state device. The computing device 210 is configured to receive data from the inertial measurement unit 209. The computing device may be coupled to the inertial measurement unit 209 according to any method described above in reference to FIG. 1. The computing device 210 is configured to determine a kinetic response to the data, as set forth in further detail below. The computing device 210 may be configured to activate the first electric motor 204 and the second electric motor 206 based upon the kinetic response. Where there is a third motor, the computing device 210 may be configured to activate the first motor 204, the second motor 206, and the third motor 212 based upon the kinetic response. The computing device 210 may be coupled to the power source of the first electric motor 204 by any method described above in reference to FIG. 1. The computing device 210 may be coupled to the power source of the second electric motor 206 by any method described above in reference to FIG. 1. The computing device 210 may be coupled to the power source of the third electric motor 212 by any method described above in reference to FIG. 1.

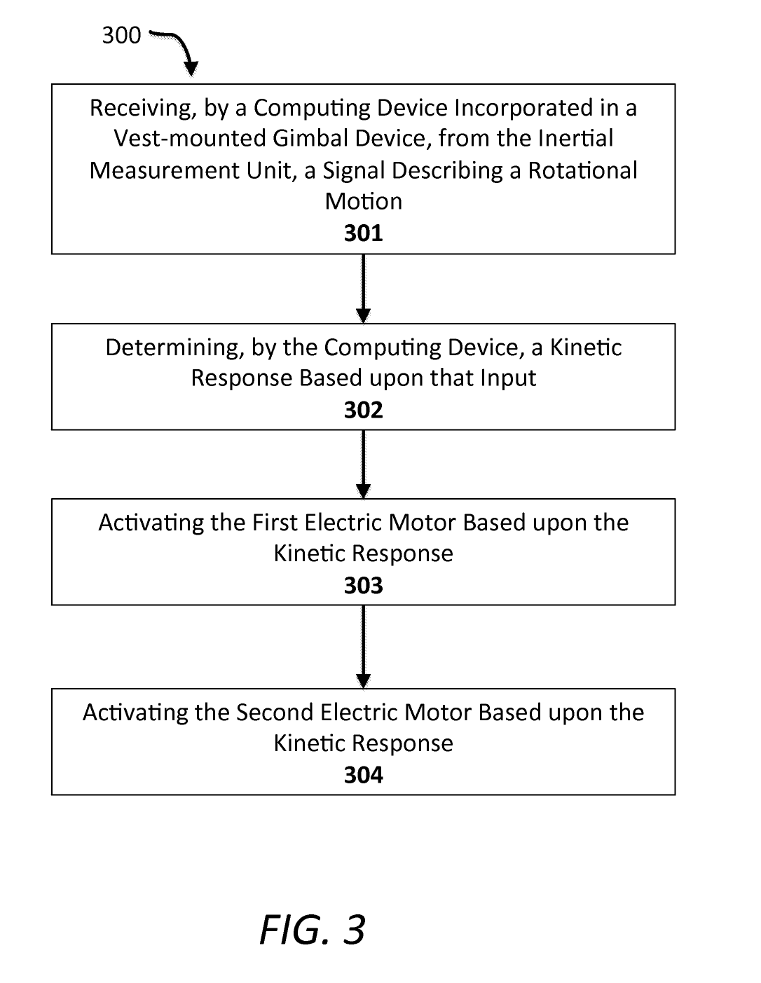

FIG. 3 illustrates some embodiments of a method 300 for automated camera attitude control. The method 300 includes receiving, by a computing device incorporated in a vest-mounted gimbal device as provided in FIGS. 2A-2C, from the inertial measurement unit, data describing a rotational motion (301). The method 300 includes determining, by the computing device, a kinetic response based upon that input (302). The method 300 includes activating the first electric motor based upon the kinetic response (303). The method 300 includes activating the second electric motor based upon the kinetic response (304).

Referring to FIG. 3 in greater detail, and by reference to FIG. 2A, the method 300 includes receiving, by the computing device 210, from the inertial measurement unit, data describing a rotational motion (301). The data may include the rotational position of the inertial measurement unit 209 relative to a coordinate system. The data may include the inertial acceleration of the inertial measurement unit 209. The data may describe a single movement; for instance, the operator may turn the inertial measurement unit 209 suddenly to one side. The data may describe several movements. As an example, an operator of the camera may be running, producing a series of small “jostling” rotational movements of the inertial measurement unit.

The method 300 includes determining, by the computing device, a kinetic response based upon that input (302). In some embodiments, determining the kinetic response involves determining an equal and opposite response to cancel out the rotational motion. The result of the kinetic response may be to keep the camera facing in substantially the same direction, without regard to the motion of the inertial measurement unit 209. Thus, where the inertial measurement unit 209 is located at the end of the arm 202, rotational motion induced in the end of the arm 202 will not translate to the camera mounted on the gimbal set 203. In other embodiments, determining the kinetic response further comprises determining an overall change of orientation. The overall change in orientation may be an estimated intended change by the operator. For instance, where the operator induces a series of movements that result in the end of the arm facing in a different direction than it initially faced, the overall change of orientation may be a smooth pan from the initial orientation of the end of the arm to the new orientation of the end of the arm 202. In this respect, the kinetic response may act as a kind of “low-pass filter” of operator movements, cancelling out quick changes in orientation that may be involuntary, while performing slower, and likely more intentional changes in orientation. The result in some embodiments is a “follow mode” wherein the operator can direct the camera by means of changes in orientation to the shot the operator intends, without involuntarily causing the camera to move in a discontinuous or jolting manner.

The method 300 includes activating the first electric motor based upon the kinetic response (303). In some embodiments, the computing device 210 calculates a component of the kinetic response that corresponds to the axis of rotation of the first electric motor 204. For instance, the computing device 210 may map the rotational motion into a spherical polar coordinate system, wherein one rotational axis corresponds to the rotational axis of the first motor 204, and the second rotational axis corresponds to the rotational axis of the second motor 206. Continuing the example, the computing device 210 may compute the portion of the kinetic response that comprises a change in angle about the rotational axis corresponding to the rotational axis of the first motor 204, and activate the power source for the first motor 204 sufficiently to cause the first motor 204 to turn through the angle of rotation calculated for that component. As another example, where there is a third motor, the computing device maps the rotational motion into a coordinate system comprising three axes of rotation corresponding to the axes of rotation of the first motor 204, the second motor 206, and the third motor 212. Continuing the example, the computing device 210 may compute the portion of the kinetic response that comprises a change in angle about the rotational axis corresponding to the rotational axis of the first motor 204, and activate the power source for the first motor 204 sufficiently to cause the first motor 204 to turn through the angle of rotation calculated for that component.

The method 300 includes activating the second electric motor based upon the kinetic response (304). In some embodiments, the computing device 210 calculates a component of the kinetic response that corresponds to the rotation of the second electric motor 206. The calculation of the component of the kinetic response that corresponds to the rotation of the second electric motor 206 may proceed according to the calculation performed for the first motor 204, as described above in reference to FIG. 3. In some embodiments, where there is a third motor, the computing device 210 activates the third electric motor based upon the kinetic response.

Some embodiments of the method 300 further involve receiving, by the computing device, from a manual data entry device, a command specifying a change in orientation, and activating, by the computing device, the first electric motor and second electric motor according to the change in orientation. The manual data entry device may be any manual entry device as described above in reference to FIG. 1. The manual data entry device may incorporate a joystick. The manual data entry device may incorporate a track-pad. The manual data entry device may incorporate a touchscreen. The manual data entry device may incorporate one or more buttons. In some embodiments, the operator enters a command to change the angle of orientation of the camera to point the camera at a subject the operator wishes to capture. The computing device 210 may activate the first electric motor 204, the second electric motor 206, and, where present, the third electric motor 212, as described above in reference to FIG. 3 for activation of the motors to accomplish the kinetic response.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A vest-mounted gimbal device, the device comprising:
a support vest, worn on the person of a user;
a support arm, mounted on the support vest;
a gimbal set, mounted on the support arm, the gimbal set comprising at least one first electric motor having a shaft, at least one second electric motor attached to the shaft of the first electric motor, the second motor having a shaft, and a camera bearing member attached to the shaft of the second electric motor;
an inertial measurement unit detecting and transmitting a rotational motion; and
a computing device configured to receive input from the inertial measurement unit, to determine a kinetic response based upon that input, and to activate the first electric motor and second electric motor based upon the kinetic response.

2. A device according to claim 1, wherein the vest further comprises a rigid frame to which the arm attaches

3. A device according to claim 1, wherein the arm further comprises at least one shock absorber.

4. A device according to claim 3, wherein the at least one shock absorber is a spring.

5. A device according to claim 1, wherein the arm further comprises at least one joint.

6. A device according to claim 5, wherein the at least one joint comprises at least one horizontally articulating joint.

7. A device according to claim 5, wherein the at least one joint comprises at least one vertically articulating joint.

8. A device according to claim 1, wherein the at least one shock absorber comprises at least one shock absorbing assembly comprising a first joint plate, a second joint plate, a first bar having a proximal end rotably joined to the first joint plate and a distal end rotably joined to the second joint plate, a second bar having a proximal end rotably joined to the first joint plate and a distal end rotably joined to the second joint plate, the second bar parallel to the first bar, and a biasing means having a bias that resists changes in distance between the first joint plate and the second joint plate.

9. A device according to claim 8, wherein the biasing means has a proximal end connected to the first joint plate near the proximal end of the first bar, and a distal end connected to the second joint plate near the distal end of the second bar.

10. A device according to claim 8, wherein the biasing means comprises a spring.

11. A device according to claim 8, wherein the at least one shock absorbing assembly is isometrically adjustable.

12. A device according to claim 1, wherein the gimbal set has at least one handle having a lower end and a hollow portion open at the lower end of the handle, and where in the gimbal set is attached to the arm by lowering the hollow portion of the handle over a pin set on the end of the arm.

13. A device according to claim 12, wherein the pin and the hollow portion are formed so that the pin fits snugly within the hollow portion.

14. A device according to claim 1, wherein the shaft of the first motor has a first axis of rotation, and the shaft of the second motor has a second axis of rotation that is not parallel to the first axis of rotation.

15. A device according to claim 1, wherein the gimbal set further comprises a third motor having a shaft, wherein the first motor is fixed to the shaft of the first motor, and wherein the computing device is further configured to activate the third motor based upon the kinetic response.

16. A device according to claim 15, wherein the shaft of the first motor has a first axis of rotation, and the shaft of the second motor has a second axis of rotation that is not parallel to the first axis of rotation, and the shaft of the third motor has a third axis of rotation, and wherein the third axis of rotation is not parallel either to the first or second axis of rotation.

17. A method for automated camera attitude control, the method comprising
receiving, by a computing device incorporated in a vest-mounted gimbal device as provided in claim 1, from the inertial measurement unit, a signal describing a rotational motion;
determining, by the computing device, a kinetic response based upon that input;
and activating the first electric motor and second electric motor based upon the kinetic response.

18. A method according to claim 17, wherein determining the kinetic response further comprises determining an equal and opposite response to cancel out the rotational motion.

19. A method according to claim 17, wherein determining the kinetic response further comprises determining an overall change of orientation.

20. A method according to claim 17, further comprising:
receiving, by the computing device, from a manual data entry device, a command specifying a change in orientation; and
activating, by the computing device, the first electric motor and second electric motor according to the change in orientation.
